(19) United States
(12) Patent Application Publication
(10) Pub. No.: US 2010/0294654 A1
(43) Pub. Date: Nov. 25, 2010

(54) MICRO-METAL-MOLD WITH PATTERNS OF GROOVES, PROTRUSIONS AND THROUGH-OPENINGS, PROCESSES FOR FABRICATING THE MOLD, AND MICRO-METAL-SHEET PRODUCT MADE FROM THE MOLD

(76) Inventors: Tae Heum Park, Seoul (KR); Chang Hee Han, Gyeonggi-do (KR)

Correspondence Address: DILWORTH & BARRESE, LLP, 1000 WOODBURY ROAD, SUITE 405, WOODBURY, NY, 11797, US

(21) Appl. No.: 12/596,052

(22) PCT Filed: Aug. 24, 2007
(86) PCT No.: PCT/KR07/04088

§ 371 Date: Aug. 3, 2010

(30) Foreign Application Priority Data
Apr. 24, 2007 (KR) 10-2007-0040094

(51) Int. Cl. C25D 1/10; B05D 3/00; C23C 28/02; C23F 1/12; C23F 1/14; B44C 1/22

(52) U.S. Cl. 204/281; 216/39; 427/275; 205/184; 216/66; 216/67; 216/83; 216/40

(57) ABSTRACT

The present invention relates to a micro metal mold for manufacturing micro metal sheet products provided with a fine or micro opening(s) or an aperture(s) together with or independently of a groove(s) and/or a protrusion(s), a method for making the mold by the electroforming or electroplating method, a method for making the mold and micro metal sheet products manufactured by using the micro metal mold. According to the invention, it is possible to manufacture micro metal sheet products, provided with fine and precise dimensions of an opening(s) as well as a groove(s) and/or a protrusion(s), under a mass production.

### TECHNICAL FIELD

The present invention relates to a micro metal mold for manufacturing a micro metal sheet product with patterns of grooves, protrusions and apertures or openings, a method of manufacturing the mold, and a micro metal sheet product made by the mold.

### BACKGROUND ART

As competition among portable electronic products has been recently intensified, components thereof are required to be fine, strong, and beautiful in design and color. Further, it is important to develop technologies for manufacturing a micro metal mold, which can meet the requirements for such components.

FIGS. 1, 2 and 3 are views illustrating a method for manufacturing a metal keypad or a method of manufacturing a metal mask in the Korean Patent Nos. 592114, 485436 and 561705.

### DISCLOSURE OF INVENTION

### Technical Problem

First of all, FIG. 1 relates to a method for manufacturing an integrated metal keypad, comprising the steps of performing a primary plating (S102) and a secondary plating (S106) with a metal such as Ni using a brass or stainless steel plate with the thickness of 0.1 to 0.5 mm as a seed layer. The method has the problems that it is not appropriate for mass production of keypads due to the complexity of its manufacturing processes, the final product including an initial brass or stainless steel plate is relatively thick, the final product has a rough surface, and the micro patterns of grooves, protrusions and openings are not elaborate in view of implemented dimension and reproductibility thereof, since patterns of grooves, protrusions and openings are separately made for each product through additional processes such as corrosive etching (S101), laser machining (S104) and pressing (S105).

FIG. 2 illustrates an invention for mechanically engraving a conductor plate to obtain an engraved model plate (engraved model, S201) with a pattern of grooves or protrusions, making a metal mold or metal-keypad electroformed product (electrodeposited plate, S202) obtained by electroforming with the engraved model plate as a mold for electroforming, surface machining of the electroformed product, manufacturing a master mold (S203) with a pattern of grooves or protrusions using the electroformed product as a mold, and reproducing subsequently a large quantity of second and third reproduced electroformed molds (S204). However, since openings for numbers, characters and figures of the final product are individually processed (S208 and S209) for each product through additional processes including mechanical engraving, laser machining, corrosive etching, sanding, diamond cutting or the like, there is a problem in that processes are complicated due to the additional process, which is disadvantageous to mass production, and the micro through-openings are not elaborate in view of implemented dimension and reproductibility thereof.

FIG. 3 relates to an invention for electroforming a nickel or a nickel alloy (S304) to manufacture a micro metal mask with desired through-openings by a photoresist application process (S301) and a photolithography process (S302 and 5303) using a conductive substrate, such as an SUS substrate, as an electrode layer. However, since a metal substrate itself is not processed, patterns of grooves and protrusions except the openings cannot be implemented through the aforementioned processes. Since the dimension accuracy thereof is high but a photoresist layer for implementing the openings should be removed every time (S306), the photoresist application and photolithography processes are essentially repeated for every product. Therefore, the complexity of its manufacturing process makes mass production unappropriate.

In addition, an invention for manufacturing a precise micro-mold through photoresist application and photolithography processes is disclosed in the Korean Patent No. 465531. In the invention, an entire substrate integrated with a plating layer plated using a conductor substrate as a seed layer and using a patterned photoresist as a mask is used as a master mold for reproduction by introducing an injection material including only plastics, ceramics and metal powders. The invention has a problem, i.e. protrusions may be formed, but grooves cannot be implemented because the substrate itself is not etched and processed, and further, openings or apertures cannot be implemented, since the master mold is not a mold for electroforming and reproducing a micro metal sheet product but a mold for an injection molding.

The manufacturing method of the present invention is intended to make micro metal sheet products and micro metal molds for forming the micro metal sheet products, wherein the micro metal sheet products can have protrusions, grooves and openings with line widths of a fine dimension of 1 micrometer and can be implemented in the form of a film having a thickness up to 10 micrometers, can have increased mechanical strength and elasticity and improved durability, with the metal seed layer and the electroformed film selected depending on required characteristics in addition to large abrasion and corrosion resistance, very smooth surface roughness like a minor and various metal colors.

### Technical Solution

The present invention is conceived to solve the problems in the prior art and carry out the above-mentioned intention. An object of the present invention is to make micro metal sheet products and micro metal molds for manufacturing the micro metal sheet products through a single process. An object of the present invention is to provide a method of manufacturing micro metal sheet products with an opening(s) using a single process. According to an aspect of the present invention for achieving these objects, there is provided a method of manufacturing a micro metal mold for electroforming a micro metal sheet product, which comprises steps of preparing a nonconducting substrate (S401); applying a primary photoresist (S402); patterning the primary photoresist by means of exposing and developing of the photoresist (S403); curing the patterned photoresist by means of a primary baking (S404); etching of the substrate for implementing desired shapes of protrusions or grooves (S405); depositing an insulating film for reinforcing insulation at electroplating and adhesion between the substrate and the metal seed layer (S406); depositing a metal seed layer for forming an electrode for electroplating (S407); applying of a secondary photoresist (S408); exposing and developing of the secondary photoresit (S409); baking of the secondary photoresit (S410); etching of the metal seed layer to implement a pattern of the through-opening(s) (S411); and making a electroformed seed product by a primary electroplating for securing durability of the metal seed layer (S412).

According to another aspect of the present invention, there is provided a method of manufacturing a micro metal sheet product, which comprises preparing a micro metal mold as described above (S501), making an electroformed product having an opening(s) with the micro metal mold (S502); forming an insulating film on the bottom of the opening(s) of the electroformed product (S503); electroforming a micro metal sheet product by using the electroformed product with the insulating film (S504); and separating the micro metal sheet product from the electroformed product (S505).

### BRIEF DESCRIPTION OF THE DRAWINGS

FIG. 1 is a view illustrating a method of manufacturing a conventional metal keypad.

FIG. 2 is a view of a manufacturing process of another conventional electroformed metal keypad.

FIG. 3 is a flowchart of a method of manufacturing another conventional metal mask.

FIG. 4 is a flowchart illustrating a method of manufacturing a micro metal mold according to an embodiment of the present invention.

FIG. 5 is a block diagram for illustrating methods of manufacturing the micro metal sheet product according to the present invention.

FIGS. 6 and 7 are views showing a micro metal mold manufactured according to an embodiment of the present invention.

FIGS. 8 to 17 are side views illustrating a process of making a micro metal sheet product using the micro metal mold according to the present invention.

FIGS. 18 to 22 are sectional views illustrating a method of manufacturing a micro metal sheet product according to an embodiment of the present invention.

FIG. 23 is a photograph showing an integrated metal keypad as a micro metal sheet product manufactured as an embodiment of the present invention.

FIG. 24 is a photograph showing an integrated metal keyboard as a micro metal sheet product manufactured as another embodiment of the present invention.

FIG. 25 is a photograph showing an integrated metal mask as a micro metal sheet product manufactured as another embodiment of the present invention.

FIGS. 26 and 27 are photographs showing a metal stamp for manufacturing an integrated biochip as a micro metal sheet product manufactured as another embodiment of the present invention.

FIGS. 28 and 29 are views schematically showing a metal stamp for manufacturing an integrated light guide plate as a micro metal sheet product manufactured as still another embodiment of the present invention.

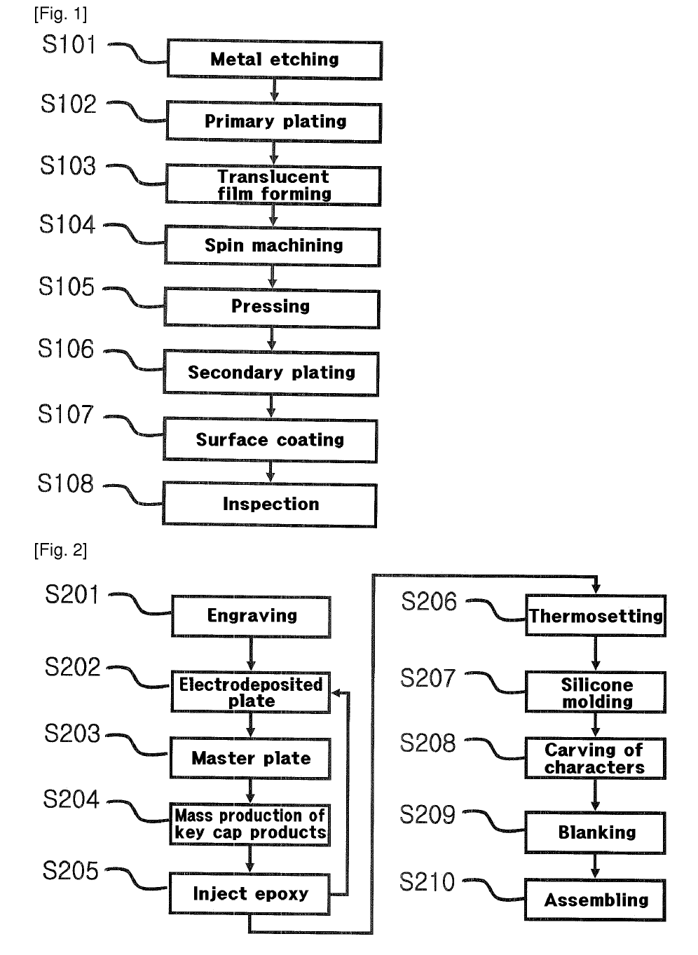

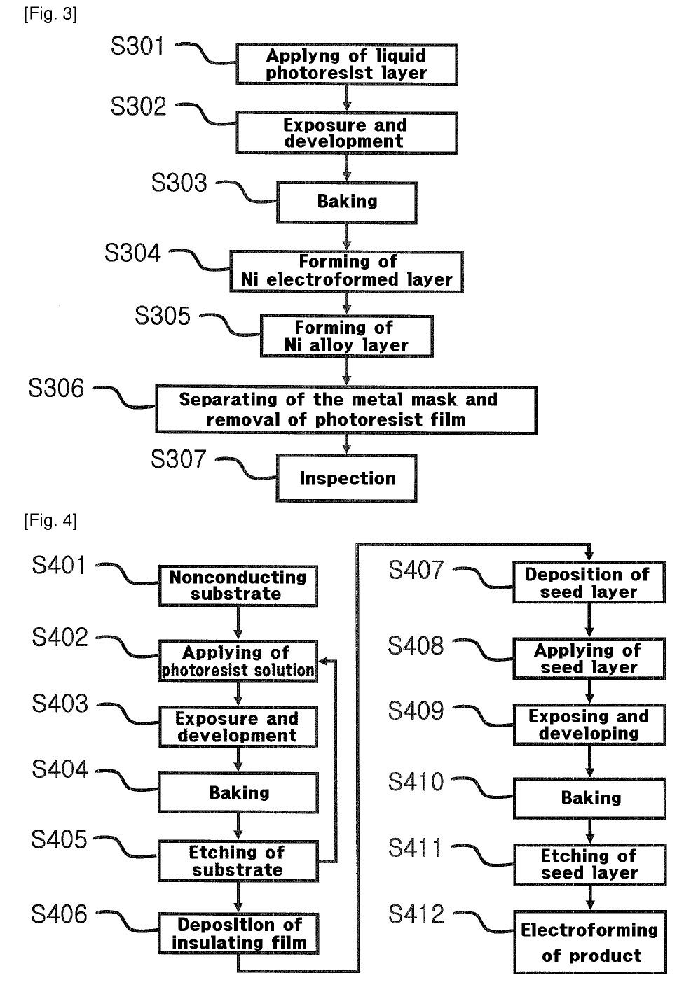

### MODE FOR THE INVENTION

Hereinafter, embodiments of the present invention will be described in detail with reference to the accompanying drawings.

FIG. 4, which is a flowchart illustrating a method of manufacturing a micro metal mold according to an embodiment of the present invention, shows a process of manufacturing a micro metal mold comprising the steps of preparing a nonconducting substrate (S401); applying a primary photoresist (S402); patterning the primary photoresist by means of exposing and developing thereof to implement a pattern of grooves and/or protrusions on a micro metal sheet product to be manufactured (S403); a primary baking for curing the patterned photoresist (S404); etching the substrate for implementing desired shapes of the protrusions and/or grooves of the micro metal sheet product to be manufactured (S405); depositing of an insulating film for reinforcing insulation at the time of electroplating and adhesion between the substrate and a metal seed layer to be deposited (S406); depositing of the metal seed layer for forming an electrode for electroforming (S407); applying of a secondary photoresist (S408); implementing a pattern of an opening(s) of the micro metal sheet product to be manufactured and a secondary exposing and developing (S409); conducting of a secondary baking (S410); etching of the metal seed layer for implementing desired shapes of the opening(s) (S411); and electroforming a seed product of the desired micro metal mold and also securing durability of the metal seed layer (S412).

The steps of the primary photoresist application (S402), patterning of the photoresist to implement a pattern of grooves and/or protrusions on a micro metal sheet product to be manufactured (S403), curing of the patterned primary photoresist (S404), and etching of the substrate for implementing desired shapes of the protrusions and/or grooves of the micro metal sheet product to be manufactured (S405) in FIG. 4 should be repeated once more, when both of the grooves and protrusions are to be formed. It is not unnecessary to repeat those steps, when either of the grooves and the protrusions are required.

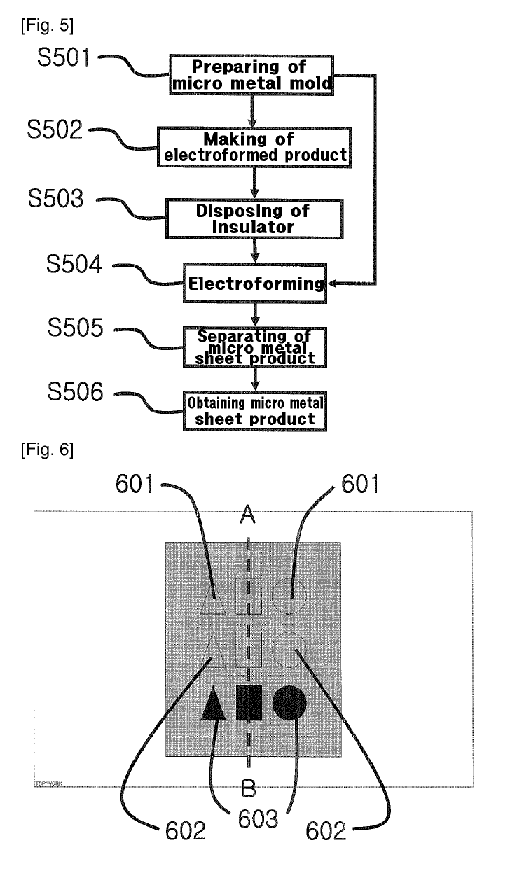

FIG. 5, illustrating methods of manufacturing micro metal sheet products according to an embodiment of the present invention, shows steps of making an electroformed micro metal sheet product in two ways by either preparing a micro metal mold (S501), making an electroformed product with the micro metal mold (S502), forming an insulating film under the opening(s) of the electroformed product (S503), electroforming a micro metal sheet product (S504) using the electroformed product, or by simple electroforming of a micro metal sheet product with the micro metal mold (S504), performing the mold release (S505), and obtaining the electroformed micro metal sheet product (S506), while electriforming of a micro metal sheet product (S504) is possible by using the micro metal mold (S501).

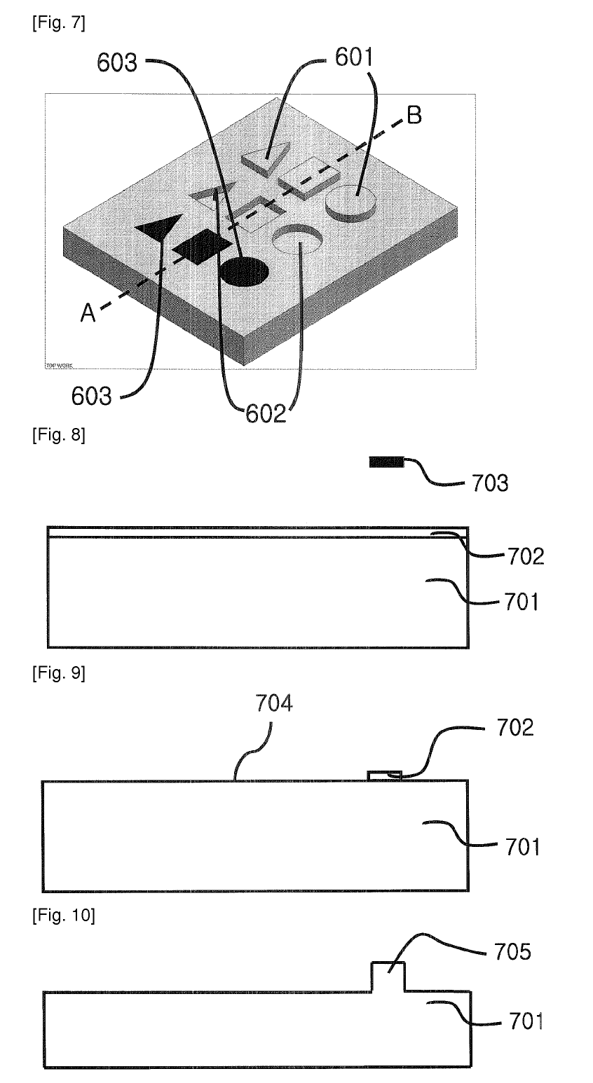

FIGS. 6 and 7 are respectively a plan view (FIG. 6) and a perspective view (FIG. 7) of a micro metal mold for manufacturing a micro metal sheet product with patterns of protrusions, grooves and openings, for the purpose of illustrating an embodiment of the micro metal mold according to the present invention.

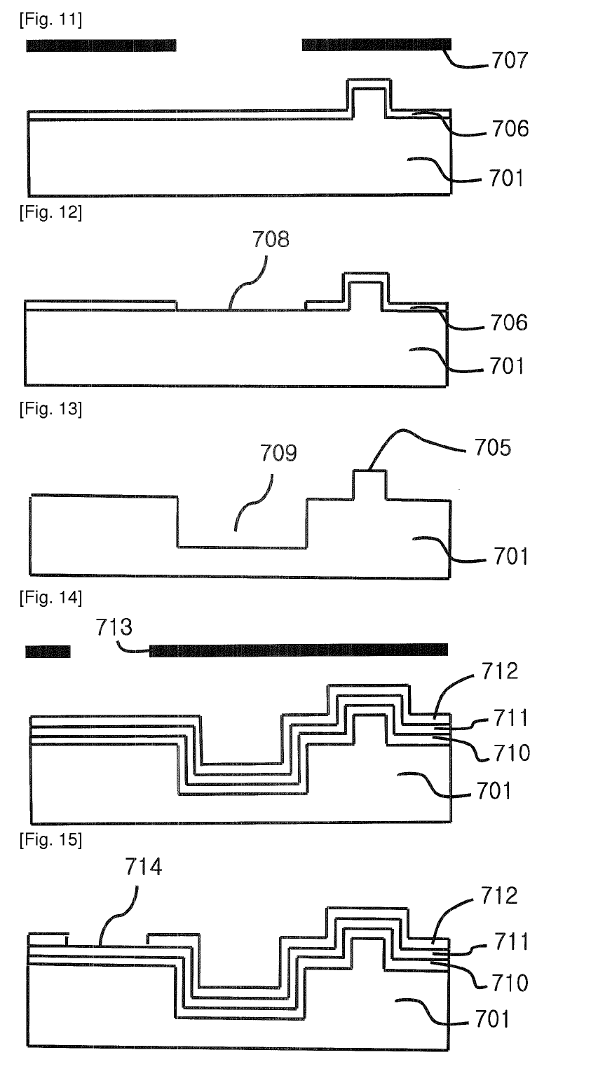

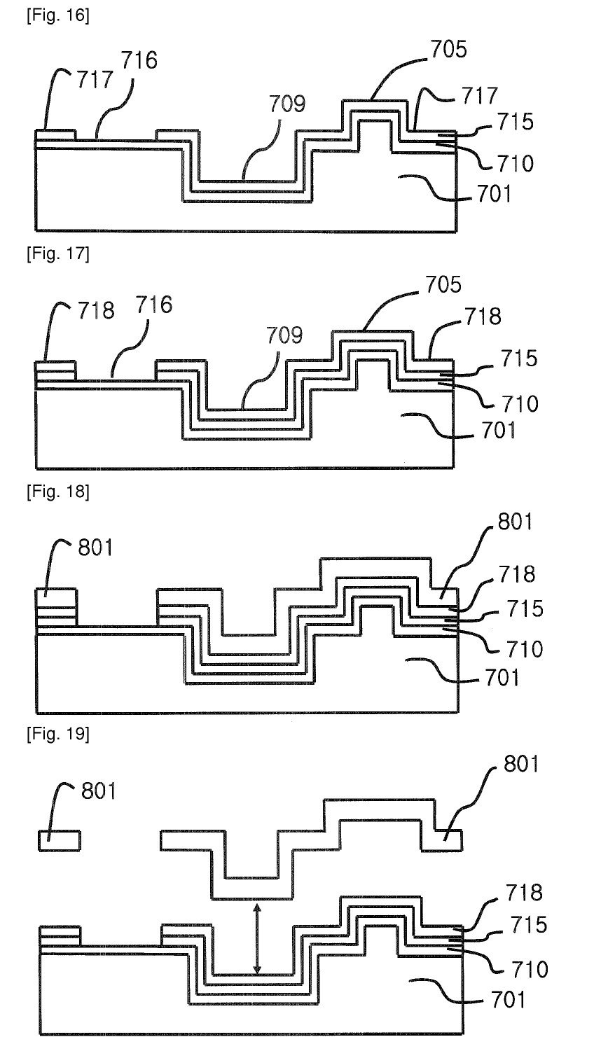

FIGS. 8 to 17 are sectional views illustrating a process of manufacturing the micro metal mold of the present invention as shown in FIGS. 6 and 7. FIGS. 8 to 17 are views taken along line A-B of FIGS. 6 and 7, sequentially illustrating the process of manufacturing the micro metal mold. A nonconducting substrate 701 is first coated with a photoresist to form a photoresist layer 702 (FIG. 8), and the photoresist layer is exposed to ultraviolet ray through a photomask 703 and developed, thereby primarily etching away a portion 704 other than a portion 705 corresponding to a protrusion(s) of a micro metal sheet product to be manufactured (FIGS. 8 to 10). Then, a second photoresist layer 706 is formed on the surface of the substrate 701 of FIG. 10, a portion of the photoresist layer 706 corresponding to a groove(s) of the micro metal sheet product is removed and baked, and subsequently, the exposed surface 708 of the substrate is secondarily etched away, thereby forming a groove 709 with a predetermined depth (see FIGS. 11 to 13). An insulating film 710 and a metal seed layer 711 are sequentially formed on the surface of the substrate 701 with a pattern of a groove(s) and a protrusion(s). The former reinforces adhesion of the surface of the substrate to the latter in addition to electric insulation and planarization of the surface of the substrate and the latter is to form an electrode layer for electroplating. Thereafter, a third photoresist layer 712 is formed on the metal seed layer 711, a part of the photoresist layer 712 corresponding to an opening or aperture to be made in the micro metal sheet product is removed by using a photomask 713 and then baked. Subsequently, the exposed part 714 of the metal seed layer is etched away, thereby exposing a part 716 of the surface of the insulating film corresponding to the opening(s) of the micro metal sheet product (see FIGS. 14 to 16). A seed body 718 of the micro metal mold is electroplated on the surface 717 of the metal seed layer of FIG. 16 by using it as an electrode, complementing mechanical durability of the metal seed layer (FIG. 17).

In the process of manufacturing the micro metal mold in FIGS. 8 to 17, it is sufficient to perform only the sequential steps of photoresist application, exposing and developing of the photoresist for patterning, baking and curing of the patterned photoresist, and etching of the substrate, when the pattern of the mold has either of grooves or protusions.

All substrates with insulation secured, such as plastic, glass, silicon and ceramic substrates, may be used as the insulator substrate. Preferably, the surface of the substrate is subject to polishing prior to photoresist application so as to obtain a planarized surface like a mirror for upper layers to be deposited in the subsequent processes.

In addition, the insulator substrate may have a curved surface of a predetermined curvature in addition to a planar surface with no curvature throughout the entire face of the substrate.

All of AZ-series positive photoresists and SU-series negative photoresists may be employed in this invention, while other photoresists (e.g., JSR series, GLM series and the like) may be used in consideration of the thickness of the photoresist layer and photosensitivity of photoresist required to implement the depth and width of the protrusions, grooves and openings to be made on the micro metal sheet product, for which the corresponding part(s) of the substrate and the metal seed layer of the micro metal mold are to be etched away.

The vacuum dry etching or wet etching method may be employed in this invention according to etch rates and isotropic/anisotropic etching characteristics required depending on the depth and the width of the protrusions, grooves and openings to be made on the micro metal sheet product, for which the corresponding part(s) of the substrate of the micro metal mold is to be etched away. The dry etching method may include an inductive coupled plasma (ICP) method, an advanced oxide etching (AOE) method, and the like. A liquid etchant may be prepared by mixing two or more acid solutions, for example, of HF, HCl, HNO₃ and H₂SO₄ at a proper ratio, or diluting any of them. Particularly, a silicon substrate is preferably etched by a vacuum dry etching method including a reactive ion etching (RIE) and a deep trench reactive ion etching (DTRIE), or a wet etching method using a KOH solution or a tetra-methyl ammonium hydroxide (TMAH) solution. In case of the wet etching method, anisotropic etching having different etching rates according to a crystal direction of the substrate may be used. Accordingly, a protrusion may have a taper shape and a groove may have an inverse-taper shape. In addition, the taper and inverse-taper shapes can be implemented through dry etching in which degree of isotropic or anisotropic etching can be controlled.

The dimension of the protrusions or grooves, which can be implemented by a photolithography method using a photoresist and a substrate etching technique, is found to be 1 micrometer to the minimum.

An insulation layer including a ceramic layer such as an oxide or nitride layer and a polymer insulation layer may be applied. However, the material is preferably selected in consideration of adhesion and durability requirements between the layers depending on the kind of the substrates under the insulation layer and the kind of the metals for the metal seed layer formed on the insulation layer. Particularly, the silicon substrate preferably has a silicon nitride layer by which tensile stress is formed or a silicon oxide film to which compression stress is applied, depending on the kind of the metals for the metal seed layer.

The methods of depositing the insulating layer may comprise a spin coating, a spray drying and a thermal oxidation depending on the materials of the insulating layers to be deposited. Alternatively, the methods of depositing the insulative layers may comprise physical vapor deposition (PVD) such as sputtering or evaporating, or chemical vapor deposition (CVD) such as low pressure chemical vapor deposition (LPCVD), plasma-enhanced chemical vapor deposition (PECVD) or metal organic chemical vapor deposition (MOCVD). Generally, a LPCDV or PECVD method is preferably used in order to deposit a ceramic insulating film such as a nitride or oxide film. Particularly, the method of depositing a silicon oxide film as an insulating layer on the silicon substrate may comprise thermal oxidation method. Preferably, a spin coating, a spray drying, an evaporating or an MOCVD method is used in order to etch a polymer insulating film.

The thickness of the insulating layer is slightly different depending on the materials of the substrate and the insulating layer. However, the insulating film may be deposited to have a thickness up to 10 micrometers. Preferably, the proper thickness of a silicon nitride film or silicon oxide film on the silicon substrate is within a range of 1 to 3 micrometers.

The step of forming the insulating film may be omitted, when the insulating property of the insulator substrate is excellent and the bonding strength of the substrate with a metal seed layer deposited on the substrate in the subsequent process is sufficiently strong.

The materials of the metal seed layer may comprise a metal selected from the group consisting of Cr, Au, Ti, Ta, Pt, Ni, Cu, Al, Zn, Fe, Co and W. However, two to five of the aforementioned metals may be combined or mixed and deposited depending on the bonding strength of the insulator substrate and insulating film and the required durability. Particularly, the combinations of Cr—Au, Cr—Au—Ni, Cr—Au—Ni—W or Cr—Au—Ni—W—Co or the combination of Ti—Pt, Ta—Pt, Ti—Pt—Ni, Ta—Pt—Ni, Ti—Pt—Ni—W, Ta—Pt—Ni—W, Ti—Pt—Ni—W—Co or Ta—Pt—Ni—W—Co show excellency in the bonding strength and durability, when a silicon oxide or silicon nitride film as an insulating layer is deposited on the silicon substrate.

The different methods of depositing the metal seed layer are applicable depending on the materials of the seed metal layer to be deposited and the materials of the substrate. However, uniform deposition can be achieved by a PVD method such as a sputtering method or an evaporating method.

The thickness of the metal seed layer may be 0.01 to 10 micrometers, and a proper total thickness may vary depending on the materials of the substrate, the insulating layer and the metal to be deposited. Particularly, the thickness of the metal seed layer is appropriately 0.1 to 0.3 micrometers, when a silicon oxide or silicon nitride film as an insulative layer is deposited on the silicon substrate. In case of a composite seed layer formed by lamination, the thickness combinations of 1:5, 1:2:5, 1:2:3:5 or 1:2:3:4:5 are superior in durability.

The different methods for etching of the metal seed layer are applicable depending on the kind of metals. However, the method for etching of the metal seed layer may comprise vacuum dry etching methods such as the RIE, the DTRIE, the ICP or the AOE method, and wet etching methods using a liquid etchant prepared by mixing two or more acid solutions, for example, of HF, HCl, HNO₃ or H₂SO₄ series at a proper ratio, or diluting any of them. Particularly, in order to eliminate equipment dependency and protect the surface of the substrate or insulating layer under the metal seed layer in etching away of the metal seed layer, the metal seed layer may be more easily and inexpensively removed with a lift-off method, in which the substrate or insulating layer is coated with a photoresist before depositing the metal seed layer, the photoresist to be left for making a desired pattern of a through-opening is developed, the metal seed layer is deposited, and then, the remaining photoresist is melted and patterned.

The dimension of the pattern for an opening formed by etching away of the metal seed layer or by the lift-off method can be 1 micrometer to the minimum.

The materials of the primary electroformed layer (seed body of the micro metal mold) may include Au, Ni, Cu, Al, Zn, Fe, Co, W, Sn, P and the like. However, the metal of primary electroformed layer may be different depending on the metal of metal seed layer thereunder, the metal of secondary electroformed layer (micro metal mold) and the use of the primary electroformed layer (e.g., whether it is used as the seed body of the micro metal mold or the mold to be separated). Preferably, the materials of the primary electroformed layer comprise one of Ni, Ni—W or Ni—Co with excellent mechanical properties, such as easiness in electroplating, strength, hardness and elasticity of the electroformed film, and chemical stability. Preferably, the thickness of the primary electroformed layer is within a range of 10 to 30 micrometers, for the purpose of easiness in releasing it from an electroformed micro metal sheet product and strength of Ni or Ni laminated film in a subsequent process.

When the primary electroformed layer (micro mold seed) is used together with the metal seed layer as an electrode for reproduction of the micro metal sheet products in a subsequent process, those micro metal sheet products can have the shapes of the protrusions and grooves formed on the metal seed layer and also the pattern of the openings. When the primary electroformed layer is used together with the metal seed layer as an electrode layer, a semi-permanent electrode layer with strong durability can be secured. However, when sufficient durability is secured with only the metal seed layer, the step of forming the primary electroformed layer (electroformed seed) may be omitted.

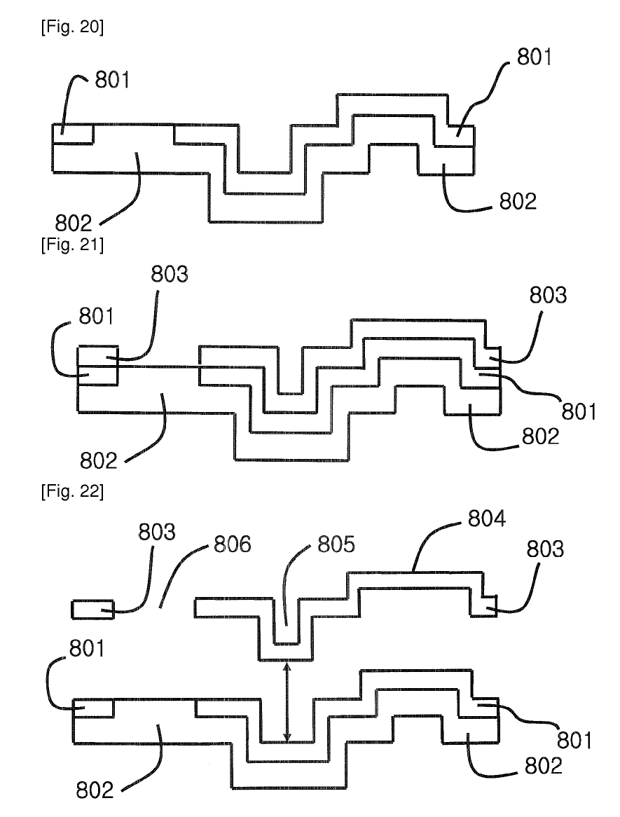

FIGS. 18 to 22 are sectional views illustrating processes of manufacturing a micro metal sheet product according to an embodiment of the present invention using the micro metal mold of FIGS. 8 to 17. By the processes of electroforming micro metal sheet products provided with patterns of a protrusion(s), a groove(s) and an opening(s) made by using the micro metal mold of the present invention, i.e. the seed body of the micro metal mold 718, or a metal seed layer 715 without the seed body formed thereon can be produced, while the surface of the seed body 718 or the metal seed layer 715 is coated with a release agent in order to separate therefrom the electroformed products 801 in the subsequent process. Subsequently, the electroformed layer (the electroformed product) 801 having the patterns of the protrusion(s), groove(s) and opening(s) in the seed body 718 or metal seed layer 715 of the micro metal mold substrate 701 as a micro metal mold is formed by an electroforming process using the seed body or the metal seed layer as an electrode (FIG. 18), and then may be separated from the micro metal mold with effect of the release agent (FIG. 19). The electroformed product 801 as shown in FIG. 19 may be used as micro metal sheet products. However, in order to secure higher mass productivity, an insulator 802 may be subsequently applied to the entire rear or front surface and the opening(s) of the electroformed product 801 and a release agent is then applied to the surface of the electroformed product for making it easy to separate the electroformed product 803 from the micro metal mold. The electroforming process is performed by using the micro metal mold as an electrode and the electroformed product 803 formed through the electroforming process is then released from the micro metal mold (see FIGS. 18 to 20). The same patterns of a protrusion(s) 804, a groove(s) 805 and an opening(s) 806 are formed in the electroformed product as those in the micro metal mold as shown in FIG. 20.

K₂Cr₂O₇ series of release agents may be used in the present invention, but other release agents (i.e. StamperPrep or the like), which do not function as a resistor in the process of electroforming but provide a release effect between metals, or separating apparatus (electro cleaning station or the like) may be used.

Materials of the electroformed products may be one of Au, Ni, Cu, Al, Zn, Fe, Co, W, Sn, P and the like, with which electroforming or electroplating is usually performed. However, the materials of electroformed products may vary depending on the materials of the seed body of the micro metal mold or metal seed layer, and necessary properties (color, and mechanical and chemical properties) and use (a general structure, a mechanical part, electronic material part and the like) of the electroformed products as the final products. Preferably, the electroformed product is electroformed with Ni, Ni—W or Ni—Co having excellent mechanical properties, such as easiness in electroplating the product, strength, hardness and elasticity of the product, and chemical stability thereof. The thickness of the electroformed product is preferably 100 micrometers or more in consideration of strength of Ni or Ni laminated film.

The ratio of the thickness of the electroformed layer of the surface and the side of the electroformed product can be controlled by adjusting the voltage, frequency and current density of the electric power applied in the electroforming process. Thus, it is possible to form a stepper shape and an inverse-stepper shape of electroformed layer on the inner wall of the opening. If an initial mask is made in consideration of the ratio of the electroforming or electroplating thickness of the top surface to that of the side surfaces of the product and the aforementioned electroforming conditions and the dimension of an opening(s) to be formed on the micro metal sheet product including the electroformed mold, it is possible to make an opening(s) with a desired shape and exact dimension.

The release agents make the electroformed products of the simple structure to be easily separated from the mold, i.e. the electroformed seed body or the metal seed layer of the metal seed layer. However, separation of the products from the mold is not easy when variations of the heights of the protrusions and the depths of the grooves are great, the shape of the opening is complex, and the thickness of the electroformed product is hundreds micrometers. A clean boundary between the metal seed layer or electroformed seed body and the electroformed product can be obtained by additionally using the separating apparatus operated by gas injection with a precise pressure and an appropriate temperature, reducing the possibility of damage given to or between the micro metal mold and the electroformed product and thereby enhancing the durability of both the mold and the products.

The insulators may include polymer resins such as commercially available epoxy for adhesion, thermosetting resin, photocurable resin and the like, which may be cured under a specific condition or after a processing time and shield the top surface including the openings of the electroformed products, or other fluid insulating material such as ceramic paste. It is known in the art that the commercially available epoxy is inexpensive but not widely used due to the long curing time, while the relatively expensive photocurable resin is widely used, as it is cured by light, showing excellent reproductivity.

An insulator is applied to the opening(s) of the electroformed mold and also a portion(s), where electroforming will not be performed, by means of either a painting method of filling the opening(s) with a fluid insulating material and applying it to the front or rear surface of the electroformed mold or a screen printing method of selectively coating only required portions thereof with the insulating material. The screen printing method is preferred due to its excellent precision and reproductivity, when the thickness of the electroformed product is 100 micrometers or less, or the dimension of the opening is very fine, such as about 100 micrometers or less.

If the dimension of screen printing with respect to the margin of the opening is adjusted, it is possible to implement an opening(s) of the micro metal sheet product with a size smaller by a predetermined electroplating thickness than the size of the opening(s) of the electroformed mold.

The materials and manufacturing processes of the micro metal sheet products are similar to those of the electroformed mold. Herein, the electroformed seed body or the initial micro metal mold of the present invention is referred to as “father mold”, and the electroformed mold products reproduced from the initial micro metal mold or the father mold is referred to as “mother mold”. The electroformed sheet product reproduced from the electroformed mold product is referred to as “son mold”, and the micro metal sheet products manufactured by subsequent electroforming with the mother mold or son mold are referred to as “reproduced electroformed products”.

When the electroforming reproduction is performed by using the top surface of the electroformed mold product or the mother mold (the boundary with the micro metal mold) as an electrode layer, direction of the protrusions and/or grooves of the electroformed sheet product (son mold) is reversed. If the electroforming reproduction is performed by using the bottom surface of the electroformed mold product or mother mold (the continuous electroforming direction) as an electrode layer, direction of the protrusions and/or grooves of the electroformed sheet product (son mold) is maintained as that of the mother mold.

The width of each of the protrusions, grooves and openings provided in the micro metal mold and micro metal sheet product manufactured by the above described processes can be controlled to 1 micrometer to the minimum, and the thickness thereof can also be implemented to 10 micrometers to the minimum. Mechanical strength and elasticity may be increased depending on the materials of the seed layer and the electroformed metal sheet, and therefore, the micro metal mold and the micro metal sheet product can have excellent durability, large abrasion resistance and corrosion resistance, very smooth surface like a mirror and color variations.

Particularly, the thickness of the key top parts of the conventional keypad or keyboard of mobile phones or notebook computers for serving to input information is more than 1 mm, occupying a large portion in thickness of the entire products. However, the thickness of the products of the present invention can be decreased to a dimension of 0.2 mm or less, decreasing the entire thickness of the mobile phones or notebook computers without deformation and damage due to forces repeatedly applied when pressing buttons thereof. The key top part can be made to have strong resistance against abrasion or corrosion occurring when being repeatedly in contact with a human body or environment, thereby being physically and chemically stable. The patterns of protrusions, grooves and openings with complexity, precision and fine dimension implemented according to the present invention will meet consumers' demand. The surface and color of the key top part can be beautifully implemented. In addition, biochip stamps including micro-array chips or micro fluidic chips that are receiving spotlights as future essential technology for diagnosing of diseases, as well as stamps for a light guide plates, metal masks and metal housings that require high preciseness and surface treatment property, can also be manufactured and mass-produced by means of the present invention.

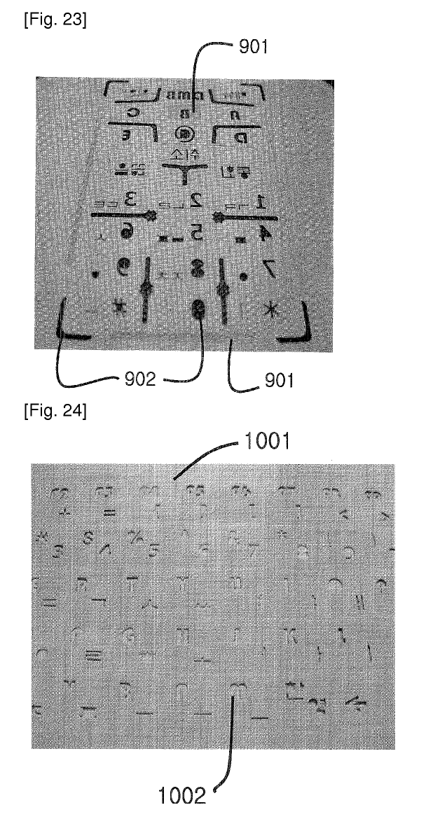

FIG. 23 shows a photograph of an integrated metal keypad manufactured according to the method of an embodiment of the present invention, which shows an integrated Ni metal keypad for a mobile phone having a size of 4.5 cm×6 cm×150 micrometers.

The width of a groove 901 provided in the metal keypad is about 1.5 millimeters, and the minimum dimension of an opening 902 is about 150 micrometers.

Preferably, the metal keypad is manufactured to have a thickness of about 130 micrometers or more, in consideration of the size of the entire micro metal sheet product and the strength of the Ni micro metal sheet product at its number and character parts, which is applied by the user for inputting information.

FIG. 24 shows a photograph of an integrated Ni metal keyboard for a notebook computer manufactured by the method of the present invention and having a size of 13 cm×10 cm×180 micrometers.

The width of the groove 1001 provided in the metal keyboard is about 1.5 millimeters, and the minimum dimension the opening 1002 is about 150 micrometers.

Preferably, the metal keyboard is manufactured to have a thickness of about 150 micrometers or more, in consideration of the size of the entire micro metal sheet product and the strength of the Ni micro metal sheet product at its number and character parts, which is applied by the user for inputting information.

A mixture of oil paint and epoxy is sprayed on the surface of the metal keyboard and dried to prevent fingerprint markings on it. When any gloss of a metal itself is not needed, the surface of the metal keyboard can be variously colored by selecting between the colors of the oil paint.

The process of manufacturing the metal keypad and the metal keyboard of FIGS. 18 to 22 and FIG. 23 will now be described in detail.

First of all, for the purpose of patterning the groove 901 or 1001 of the metal keypad or metal keyboard as a micro metal sheet product to be manufactured, a silicon wafer with a diameter of 4 inches (for the metal keyboard) or 6 inches (for the metal keypad) and a thickness of 500 micrometers is selected as a substrate of a micro metal mold. Thereafter, the substrate is coated with an AZ series positive photoresist by a spin coating method and the photoresist is baked to be solidified, and the photoresist coated on the surface and solidified is exposed to ultraviolet (UV) ray passing through a polymer film photomask that is penetrated with a pattern of a desired grooves and then developed with a CD series developer. Subsequently, the exposed surface of the silicon wafer that is not protected by the photoresist is etched away up to about 40 micrometers deep by a DTRIE method, and the remaining photoresist is then removed, thereby forming a groove with the desired shape.

A silicon nitride (Si₃N₄) for forming an electrical passivation layer is deposited on the silicon wafer 606 with the etched groove to have a thickness up to 1 micrometer by an LPCVD method, thereby forming an insulative film that is a silicon nitride film integrated with a silicon substrate to provide electrical insulation and adhesion enhancement. Thereafter, a metal seed layer is formed by sequentially depositing a metallic material of Ta—Pt with a thickness of 0.02 to 0.1 micrometer on the insulating layer by a sputtering method. In order to implement an opening 902 or 1102 of the micro metal sheet product, i.e. the metal keypad or the metal keyboard, the metal seed layer is coated with an AZ series positive photoresist by a spin coating method and then the photoresist is baked and cured, and the surface coated with the photoresist is exposed to ultraviolet (UV) ray passing through a polymer film photomask that is penetrated with a pattern of a desired opening and then developed by a developer. Subsequently, the metal seed layer is removed by completely etching away the exposed surface of the metal seed layer, which is not protected by the photoresist, by an ICP method, and the remaining photoresist is then removed to allow the lower insulating layer of a portion, at which the opening of the micro metal sheet product will be formed, to be exposed. The entire metal seed layer being vacuum deposited is coated with a release agent of K₂Cr₂O₇ for separating an electroformed product in a subsequent process, and Ni is electroformed with a thickness of about 20 micrometers on the metal seed layer in order to form an electroformed seed body having durability of an electrode layer on exposed surface of the metal seed layer. Then, the electroformed seed body is used together with the metal seed layer as an electrode for the electroforming reproduction. An electroformed product is made by electroplating Ni again to a thickness of 130 micrometers using the electrode layer as an electrode for electroforming, wherein the electrode layer includes the substrate etched to have the groove, the metal seed layer patterned to have an opening shape and the electroformed seed product. After the electroforming process, the electroformed seed body coated with the release agent may be completely separated from the mold electroformed product, thereby obtaining a electroformed product having desired grooves 901 and 1001 and openings 902 and 1002.

The electroformed product may be used as a desired micro metal sheet product, i.e. a metal keypad or metal keyboard. However, in order to reproduce the micro metal sheet product of the present invention in large quantities, a bottom surface of the electroformed product is coated with commercially available epoxy by a painting method, so that the opening of the mold electroformed product is completely filled with an insulator, and the bottom surface of the mold electroformed product is coated with a release agent. Thereafter, the electroformed product having the opening filled with the insulator is fixed to a nonconducting substrate to function as an electrode layer for electroplating. Then, Ni is electroplated on the mold electroformed product in a thickness of about 130 micrometers, thereby producing an electroformed product which has the grooves 901 and 1001 and openings 902 and 1002 of the mold electroformed product. The electroformed product can be used as a desired metal keypad or metal keyboard.

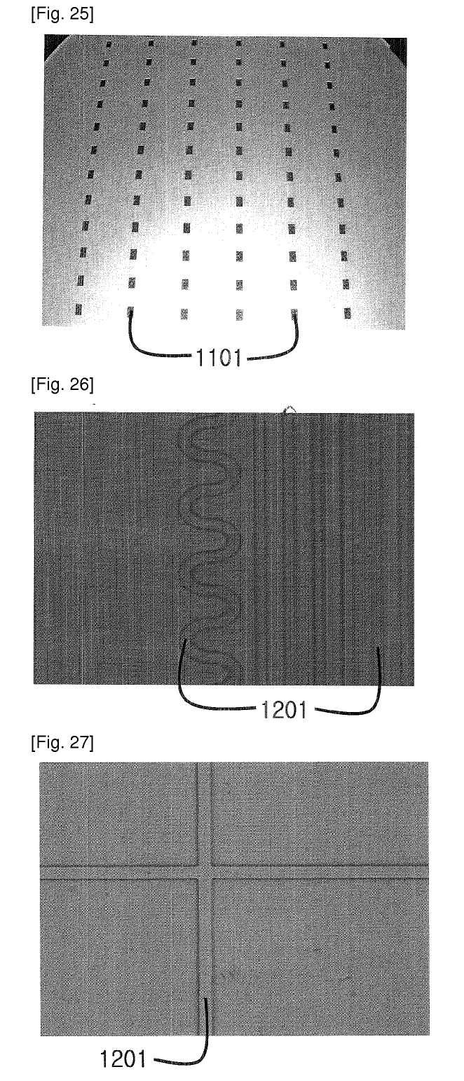

FIG. 25 shows a photograph of an integrated metal mask manufactured by the method of the present invention, which shows an integrated Ni metal mask for shielding electro beam or light, manufactured to have a diameter of 10 centimeters and a thickness of 200 micrometers.

The width of the opening 1101 provided in the metal mask is about 1.5 millimeters.

Preferably, the metal mask is manufactured to have a thickness of about 150 micrometers or more, in consideration of the strength of a Ni—W metal sheet product and the ability of electromagnetic wave shielding.

FIGS. 26 and 27 shows photomicrographs of metal stamps for making an integrated biochip according to the present invention, which show integrated Ni metal stamps for manufacturing micro fluidic biochips with a thickness of 400 micrometers to have curved or straight lines (FIG. 26) and a cross-shaped micro channel (FIG. 27).

The channel quality induced from quality of the metal stamp for manufacturing a biochip may determine the speed, uniformity of fluid flow and reproductivity of the biochip, and the shape and dimension of the channel will vary depending on the object of the biochip. Generally, the finer the dimension of the channel width becomes, the more difficult it is to secure the uniformity of the dimension of the channel and the surface of the channel. The more the dimension and surface of channel are uniform, the more the value of the biochip, as a micro fluid flow chip, increases. The width of a groove 1301 provided in the above described metal stamp for manufacturing a biochip is about 10 micrometers, which is very fine, and the surface of the groove 1301 is also uniform in smoothness.

Preferably, the thickness of the metal stamp for manufacturing a biochip is about 300 micrometers or more, in consideration of the size of the entire micro metal sheet product, the strength of a Ni metal sheet product and the strength required for the plastic injection mold.

The processes of manufacturing the metal stamp for the biochip of FIGS. 26 and 27 will now be described in detail.

First of all, for the purpose of patterning a groove or channel of the metal stamp for manufacturing a biochip as a micro metal sheet product, a silicon wafer with a diameter of 4 inches and a thickness of 500 micrometers was selected as a substrate of a micro metal mold. The substrate was coated with an SU series negative photoresist by a spin coating method and then the photoresist was baked and solidified, and the solidified photoresist was exposed to ultraviolet (UV) ray passing through a soda lime photomask that was penetrated in an inverse pattern of a desired groove and then developed by an SU-remover series developer. Subsequently, the exposed surface of the silicon wafer that was not protected by the photoresist was etched away to a depth of about 10 micrometers deep by an RIE method, and the remaining photoresist was then removed, thereby forming a groove or channel with a desired shape. A silicon oxide (SiO₂) as an electrical passivation layer was deposited on the silicon wafer with the etched groove to have a thickness up to 1 micrometer by a thermal oxidation method, and an insulative film that was a silicon oxide film integrated with the silicon substrate was formed to provide electrical insulation and adhesion enhancement. Thereafter, a metal seed layer was formed by sequentially vacuum depositing a metallic material of Cr—Au with a thickness of 0.02 to 0.1 micrometer on the insulating layer by an evaporating method. Ni was then electroplated with a thickness of 400 forming an electroformed product, while the metal seed layer was coated with a release agent of K₂Cr₂O₇ prior to the electroplating, in order to help separate the electroformed product from the seed layer. After electroplating was completed, the electroformed product was separated from the seed layer, thereby the electroformed product having a desired groove or channel 1201 being obtained.

The electroformed product may be used as a desired micro metal sheet product that is a metal stamp for manufacturing a biochip. However, in order to reproduce the micro metal sheet products of the present invention in large quantities, a rear surface of the electroformed product may be coated with a release agent and then, the electroformed product may be fixed to function as an electrode layer for electroplating, and Ni is electroplated on the electroformed product with a thickness of about 400 micrometers, thereby producing a reproduced electroformed product to which a groove or channel 1201 of the electroformed product are transferred as they are. The reproduced electroformed products are to be used as desired metal stamps for manufacturing biochips.

As can be seen from FIGS. 23 to 27, the various protrusions, grooves or openings implemented in the integrated micro metal mold made by the technology disclosed in the present invention are highly fine and precise. Further, it is possible to produce a light, compact micro metal sheet products, and the smoothness of the surface of the micro metal sheet product is very excellent, thereby rendering a very beautiful appearance.

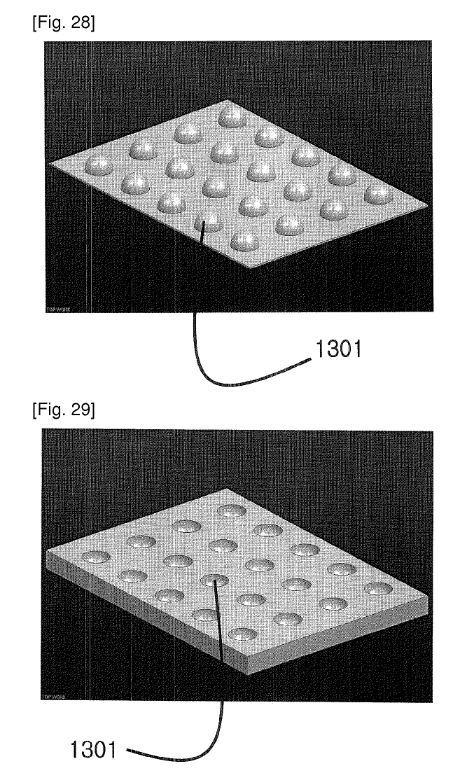

FIGS. 28 and 29 are schematic views showing two metal stamps for manufacturing integrated light guide plates according to an embodiment of the present invention, i.e. a convex lens shape (FIG. 28) and a concave lens shape (FIG. 29) to be used in a back light unit (BLU) for LCD display technologies.

The micro lenses used in the metal stamp can determine light guide efficiency of the light guide plate and luminance, brightness and uniformity of the light. Generally, the finer the dimension of the micro lens is, the more uniform the spherical surface of the micro lens and the curvature of the micro lens are and the light guide characteristic of the lens is improved. A micro lens (1301) may be implemented to have a diameter of about 10 micrometers to the minimum.

Preferably, the thickness of the metal stamp for a light guide plate is about 300 micrometers or more, in consideration of the size of the entire micro metal sheet product, the strength of a Ni—W metal sheet product and the strength required for plastic injection mold.

### INDUSTRIAL APPLICABILITY

The present invention relates to a micro metal mold, a method of manufacturing the mold and a micro metal sheet product made by the mold, and more particularly, to a method of manufacturing a micro metal mold having grooves, protrusions and openings with a minimum dimension of 1 micrometer by means of preservation of a electroplated electrode layer, and a micro metal sheet product electroformed by using the micro metal mold of the present invention. Accordingly, there is an advantage in that a desired micro metal sheet product with a minimum thickness of 10 micrometers can be manufactured by a one-time electroforming process.

Particularly, the micro metal sheet products manufactured according to the present invention is different from those of the prior art in that grooves, protrusions and openings with complex shapes such as numbers, characters, figures and patterns can be simultaneously implemented on the surface of the micro metal sheet product, the groove and topenins, or the protrusions and openings can be overlapped with each other, the thickness of the micro metal sheet product and the dimension of the grooves, protrusions and openings are fine and precise, and mass productivity of the micro metal sheet products are excellent.

In the micro metal molds and the micro metal sheet products according to the present invention, durability can be improved by increasing mechanical strength, hardness and elasticity resulted from the appropriate materials used. The micro metal mold and the micro metal sheet product can have large abrasion resistance, corrosion resistance and chemical resistance, very smooth surface like a minor and color variations.

According to the present invention, the method of massive production of micro metal sheet products having grooves, protrusions and openings with complex shapes and patternscan be applied to manufacturing structural products, metal keypads and keyboards, metal housings, metal accessories, metal plates, metal masks, dials (number plates), light guide plates, metal stamps for manufacturing biochips, and the like. Accordingly, an important solution is disclosed by the present invention in the fileds of component manufacture in that high precision, high capacity and mass productivity can be secured.

1-42. (canceled)

43. A micro metal mold for electroforming or electroplating a micro metal sheet product, comprising:
a nonconducting substrate having one or both of a groove(s) and a protrusion(s) formed by etching; and
a metal seed layer formed on a top surface of the substrate and having the groove(s) and/or the protrusion(s) therein corresponding to that or those of the substrate.

44. The micro metal mold as claimed in claim 43, further comprising an insulating film formed between the substrate and the metal seed layer.

45. The micro metal mold as claimed in claim 43, wherein the metal seed layer has a cutaway portion(s) corresponding to an opening(s) of a micro metal sheet product to be electroformed therewith.

46. The micro metal mold as claimed in claim 43, further comprising an electroformed mold layer of a predetermined thickness electroplated with and on the metal seed layer.

47. The micro metal mold as claimed in claim 46, wherein the electroformed mold layer has a cutaway portion(s) corresponding to an opening(s) of a micro metal sheet product to be electroformed therewith, which is aligned with the corresponding cutaway portion(s) of the metal seed layer.

48. A micro metal mold for electroforming or electroplating a micro metal sheet product, comprising:
a nonconducting substrate having a planar top surface; and
a metal seed layer formed on the substrate to have a cutaway portion(s) corresponding to an opening(s) of a micro metal sheet product to be electroformed with the metal seed layer.

49. The micro metal mold as claimed in claim 48, further comprising an insulating film formed between the substrate and the metal seed layer.

50. The micro metal mold as claimed in claim 48, further comprising a electroformed mold layer formed on the metal seed layer.

51. The micro metal mold as claimed in claim 43, wherein the material of the substrate is selected from the group consisting of a silicon, a plastics, a glass and a ceramic.

52. The micro metal mold as claimed in claim 44, wherein the insulating film is a nitride or oxide film.

53. The micro metal mold as claimed in claim 43, wherein the material of the metal seed layer is one or the more of the metals selected from the group consisting of Cr, Au, Ti, Ta, Pt, Ni, Cu, Al, Zn, Fe, Co and W.

54. The micro metal mold as claimed in claim 46, wherein the material of the electroformed mold layer is one or the more of the metals selected from the group consisting of Au, Ni, Cu, Al, Zn, Fe, Co, W, Sn, and P.

55. The micro metal mold as claimed in claim 50, wherein the material of the electroformed mold layer is one or the more of the metals selected from the group consisting of Au, Ni, Cu, Al, Zn, Fe, Co, W, Sn, and P.

56. A method for producing a micro metal mold for electroforming or electroplating micro metal sheet products therewith, comprising:
forming one or more grooves and/or one or more protrusions on a nonconducting substrate by an etching method, and
forming a metal seed layer on the substrate having the groove(s) and/or the protrusion(s) corresponding to that or those of the groove(s) and/or the protrusion(s) on the substrate.

57. The method as claimed in claim 56, further comprising:
forming an insulating film on the substrate prior to forming the metal seed layer thereon.

58. The method as claimed in claim 57, wherein the metal seed layer formed on the substrate or the insulating film has a cutaway portion(s) corresponding to an opening(s) of a micro metal sheet product to be electroformed therewith.

59. The method as claimed in claim 56, further comprising
forming an electroformed mold layer on the metal seed layer, provided with a cutaway portion(s) corresponding to that or those of the metal seed layer.

60. A method for producing a micro metal mold for electroforming or electroplating micro metal sheet products therewith, comprising:
processing a nonconducting substrate to have a planar top surface, and
forming a metal seed layer on the substrate, having a cutaway portion(s) corresponding to that or those of the opening(s).

61. The method as claimed in claim 60, further comprising:
forming an insulating film between the substrate and the metal seed layer.

62. The method as claimed in claim 60, further comprising
forming an electroformed mold layer on the metal seed layer, provided with a cutaway portion(s) corresponding to that or those of the metal mold layer.

63. The method as claimed in claim 56, wherein the material of the substrate is selected from the group consisting of a silicon, a plastics, a glass and a ceramic.

64. The method as claimed in claim 56, wherein the etching of the substrate is performed by one of the inductive coupled plasma (ICP) method, the advanced oxide etching (AOE) method, the reactive ion etching (RIE) method, the deep trench reactive ion etching (DTRIE) method, or the wet etching method.

65. The method as claimed in claim 56, wherein the material of the metal seed layer is one or the more of the metals selected from the group consisting of Cr, Au, Ti, Ta, Pt, Ni, Cu, Al, Zn, Fe, Co and W.

66. The method as claimed in claim 56, wherein the metal seed layer is formed by one of the sputtering method or the Evaporating method.

67. The method as claimed in claim 58, wherein the etching of the cutaway portion(s) of the metal seed layer is performed by one of the reactive ion etching (RIE) method, the deep trench reactive ion etching (DTRIE) method, the inductive coupled plasma (ICP) method, the advanced oxide etching (AOE) method, the wet etching method or the lift-off method.

68. The method as claimed in claim 57, wherein the insulating film is a nitride or oxide film.

69. The method as claimed in claim 68, wherein the nitride film is formed by one of the sputtering method, the evaporating method, the low pressure chemical vapor deposition (LPCVD) method, the plasma-enhanced chemical vapor deposition (PLCVD) method or the metal organic chemical vapor deposition (MOCVD) method.

70. The method as claimed in claim 68, wherein the oxide film is formed by one of the sputtering method, the evaporating method, the low pressure chemical vapor deposition (LPCVD) method, the plasma-enhanced chemical vapor deposition (PLCVD) method or the metal organic chemical vapor deposition (MOCVD) method.

71. The method as claimed in claim 59, wherein the material of the electroformed mold layer is one or the more of the metals selected from the group consisting of Au, Ni, Cu, Al, Zn, Fe, Co, W, Sn, and P.

72. The method as claimed in claim 62, wherein the material of the electroformed mold layer is one or the more of the metals selected from the group consisting of Au, Ni, Cu, Al, Zn, Fe, Co, W, Sn, and P.

73. The method as claimed in claim 59, wherein the electroformed mold layer is made by using the metal seed layer as the electrode for electroplating.

74. The method as claimed in claim 62, wherein the electroformed mold layer is made by using the metal seed layer as the electrode for electroplating.

75. The method as claimed in claim 59, wherein the cutaway portion(s) of the electroformed mold layer is formed in accordance with the portion(s) of either the substrate or the insulating film exposed by the cutaway portion(s) of the metal seed layer.

76. The method as claimed in claim 62, wherein the cutaway portion(s) of the electroformed mold layer is formed in accordance with the portion(s) of either the substrate or the insulating film exposed by the cutaway portion(s) of the metal seed layer.

77. The micro metal mold as claimed in claim 48, wherein the material of the substrate is selected from the group consisting of a silicon, a plastics, a glass and a ceramic.

78. The micro metal mold as claimed in claim 49, wherein the insulating film is a nitride or oxide film.

79. The micro metal mold as claimed in claim 48, wherein the material of the metal seed layer is one or the more of the metals selected from the group consisting of Cr, Au, Ti, Ta, Pt, Ni, Cu, Al, Zn, Fe, Co and W.

80. The method as claimed in claim 60, wherein the material of the substrate is selected from the group consisting of a silicon, a plastics, a glass and a ceramic.

81. The method as claimed in claim 60, wherein the material of the metal seed layer is one or the more of the metals selected from the group consisting of Cr, Au, Ti, Ta, Pt, Ni, Cu, Al, Zn, Fe, Co and W.

82. The method as claimed in claim 60, wherein the metal seed layer is formed by one of the sputtering method or the Evaporating method.

83. The method as claimed in claim 60, wherein the etching of the cutaway portion(s) of the metal seed layer is performed by one of the reactive ion etching (RIE) method, the deep trench reactive ion etching (DTRIE) method, the inductive coupled plasma (ICP) method, the advanced oxide etching (AOE) method, the wet etching method or the lift-off method.

84. The method as claimed in claim 61, wherein the insulating film is a nitride or oxide film.
